(19) United States
(12) Patent Application Publication
(10) Pub. No.: US 2013/0053477 A1
(43) Pub. Date: Feb. 28, 2013

(54) Hydrophobic Cellulosic Substrates And Methods For Producing The Same

(71) Applicants: Michael Robert Asa Costello, Linwood, MI (US); Kevin Dale Lewis, Sanford, MI (US); William James Schulz, JR., Midland, MI (US)

(72) Inventors: Michael Robert Asa Costello, Linwood, MI (US); Kevin Dale Lewis, Sanford, MI (US); William James Schulz, JR., Midland, MI (US)

(73) Assignee: DOW CORNING CORPORATION, MIDLAND, MI (US)

(21) Appl. No.: 13/696,430

(22) PCT Filed: May 16, 2011
(86) PCT No.: PCT/US11/36577

§ 371 Date: Nov. 6, 2012

Related U.S. Application Data
(60) Provisional application No. 61/397,696, filed on May 17, 2010.

(51) Int. Cl. C08L 1/00; B32B 5/16; B32B 21/00; B05D 7/00

(52) U.S. Cl. 524/35; 427/344; 428/220; 428/221; 428/541

(57) ABSTRACT

Methods for rendering a cellulosic substrate hydrophobic include providing a plurality of halosilane compounds comprising at least a first halosilane compound and a second halosilane compound different from the first halosilane compound, wherein the plurality of halosilane compounds comprises a total halosilane concentration comprising 20 mole percent or less of monohalosilanes, 70 mole percent or less of monohalosilanes and dihalosilanes and at least 30 percent of trihalosilanes and tetrahalosilanes, and, treating the cellulosic substrate with the plurality of halosilane compounds, wherein the plurality of halosilane compounds are applied as one or more liquids.

### TECHNICAL FIELD

The present disclosure is generally directed at rendering cellulosic substrates hydrophobic, and, more specifically, rendering cellulosic substrates hydrophobic with a plurality of halosilane compounds applied as one or more liquids.

### BACKGROUND

Cellulosic substrates such as paper and cardboard products encounter various environmental conditions based on their intended use. For example, cardboard is often used as packaging material for shipping and/or storing products and must provide a durable enclosure that protects its contents. Some such environmental conditions cellulosic substrates may face are water through rain, temperature variations which may promote condensation, flooding, snow, ice, frost, hail or any other form of moisture. Water in its various forms may threaten a cellulosic substrate by degrading its chemical structure through hydrolysis and cleavage of the cellulose chains and/or breaking down its physical structure via irreversibly interfering with the hydrogen bonding between the chains, thus decreasing its performance in its intended use.

One way of preserving cellulosic substrates is to prevent the interaction of water with the cellulosic substrate. For example, films may be applied to the surface of the cellulosic substrates to prevent water from contacting the cellulosic substrate directly. However, films can degrade or become mechanically compromised and become less effective over time. Films and other “surface only” treatments also have the inherent weakness of poorly treated substrate edges. Even if the edges can be treated to impart hydrophobicity to the entire substrate, any rips, tears, wrinkles, or folds in the treated paper can result in the exposure of non-treated surfaces that are easily wetted and can allow wicking of water into the bulk of the cellulosic substrate. Another option is to treat the cellulosic substrate with a single chlorosilane so that the chlorosilane diffuses into and impregnates the cellulosic substrate. However, in doing so, the relatively low deposition efficiency of the chlorosilane may result in additional costs incurred through manufacturing. Furthermore, chlorosilanes are often commercially produced as a mixture thereby requiring additional processing for the application of a single chlorosilane. Therefore, there may be a desire for alternative methods for rendering cellulosic substrates hydrophobic utilizing at least two different chlorosilanes.

### SUMMARY

According to one embodiment of the present invention, a method for rendering a cellulosic substrate hydrophobic is disclosed. The method includes providing a plurality of halosilane compounds including at least a first halosilane compound and a second halosilane compound different from the first halosilane compound, wherein the plurality of halosilane compounds comprises a total halosilane concentration comprising 20 mole percent or less of monohalosilanes, 70 mole percent or less of monohalosilanes and dihalosilanes and at least 30 percent of trihalosilanes and tetrahalosilanes, and, treating the cellulosic substrate with the plurality of halosilane compounds, wherein the plurality of halosilane compounds are applied as one or more liquids.

According to another embodiment, a hydrophobic cellulosic substrate is disclosed. The hydrophobic cellulosic substrate includes 90 weight percent to 99.99 weight percent of a cellulosic substrate, and, 0.01 weight percent to 10 weight percent of a silicone resin, wherein the silicone resin is produced from treating the cellulosic substrate with a plurality of halosilane compounds including at least a first halosilane compound and a second halosilane compound different from the first halosilane compound, wherein the plurality of halosilane compounds are applied as one or more liquids and comprises 20 mole percent or less of monohalosilanes, 70 mole percent or less of monohalosilanes and dihalosilanes and at least 30 percent of trihalosilanes and tetrahalosilanes.

These and additional objects and advantages provided by the embodiments of the present invention will be more fully understood in view of the following detailed description.

### DETAILED DESCRIPTION

Cellulosic substrates can be rendered hydrophobic by treating the cellulosic substrates with a plurality of halosilane compounds wherein the plurality of halosilane compounds comprises a first halosilane compound and a second halosilane compound different from the first halosilane compound. The plurality of halosilane compounds can comprise a total halosilane concentration of 20 mole percent or less of monohalosilanes and 70 mole percent or less of monohalosilanes and dihalosilanes and be applied as one or more liquids such that the plurality of halosilane compounds can deeply penetrate the cellulosic substrate and produce a silicone resin such that the entire volume of the cellulosic substrate is rendered hydrophobic. In addition, by varying the amounts and types of halosilane compounds, the physical properties of the cellulosic substrate may be altered.

Cellulosic substrates are substrates that substantially comprise the polymeric organic compound cellulose having the formula (C₆H₁₀O₅)ₙ where n is any integer. Cellulosic substrates possess —OH functionality, contain water and can include, for example, paper, wood and wood products, cardboard, wallboard, textiles, starches, cotton, wool, other natural fibers and any other similarly related material or composites derived there from. Depending on the cellulosic substrate's intended application and manufacturing process, the cellulosic substrate can comprise sizing agents and/or additional additives or agents to alter its physical properties or assist in the manufacturing process. Exemplary sizing agents include starch, rosin, alkyl ketene dimer, alkenyl succinic acid anhydride, styrene maleic anhydride, glue, gelatin, modified celluloses, synthetic resins, latexes and waxes. Other exemplary additives and agents include bleaching additives (such as chlorine dioxide, oxygen, ozone and hydrogen peroxide), wet strength agents, dry strength agents, fluorescent whitening agents, calcium carbonate, optical brightening agents, antimicrobial agents, dyes, retention aids (such as anionic polyacrylamide and polydiallydimethylammonium chloride), drainage aids (such as high molecular weight cationic acrylamide copolymers, bentonite and colloidal silicas), biocides, fungicides, slimacides, talc and clay and other substrate modifiers such as organic amines including triethylamine and benzylamine. It should be appreciated that other sizing agents and additional additives or agents not listed explicitly herein may alternatively be applied, alone or in combination. For example, where the cellulosic substrate comprises paper, the paper can also comprise or have undergone bleaching to whiten the paper, starching or other sizing operation to stiffen the paper, clay coating to provide a printable surface, or other alternative treatments to modify or adjust its properties. Furthermore, cellulosic substrates such as paper can comprise virgin fibers, wherein the paper is created for the first time from non-recycled cellulose compounds, recycled fibers, wherein the paper is created from previously used cellulosic materials, or combinations thereof.

The cellulosic substrate may vary in thickness and/or weight depending on the type and dimensions of the substrate. The thickness of the cellulosic substrate can range from less than 1 mil (where 1 mil=0.001 inches=0.0254 millimeters (mm)) to greater than 150 mils (3.81 mm), from 10 mils (0.254 mm) to 60 mils (1.52 mm), from 20 mils (0.508 mm) to 45 mils (1.143 mm), from 30 mils (0.762 mm) to 45 mils (1.143 mm) or have any other thickness that allows it to be treated with the halosilane solution as will become appreciated herein. The thickness of the cellulosic substrate can be uniform or vary and the cellulosic substrate can comprise one continuous piece of material or comprise a material with openings such as pores, apertures, and holes disposed therein. Furthermore, the cellulosic substrate may comprise a single flat cellulosic substrate (such as a single flat piece of paper) or may comprise a folded, assembled or otherwise manufactured cellulosic substrate. For example, the cellulosic substrate can comprise multiple substrates glued, rolled or woven together or can comprise varying geometries such as corrugated cardboard. In addition, the cellulosic substrates can comprise a subset component of a larger substrate such as when the cellulosic substrate is combined with plastics, fabrics, non-woven materials and/or glass. It should be appreciated that cellulosic substrates may thereby embody a variety of different materials, shapes and configurations and should not be limited to the exemplary embodiments expressly listed herein.

Furthermore, as will become better appreciated herein, the cellulosic substrate can be provided in an environment with a controlled temperature. For example, the cellulosic substrate can be provided at a temperature range of −40° C. to 200° C., at a range of 10° C. to 80° C., or at a temperature of 22° C. to 25° C.

As disclosed herein, the cellulosic substrate is treated with a plurality of halosilane compounds applied as one or more liquids to render it hydrophobic. The plurality of halosilane compounds comprises at least a first halosilane compound and a second halosilane compound different from the first halosilane compound. The phrase “different from” as used herein means two non-identical halosilane compounds so that the cellulosic substrate is not treated with a single halosilane compound. Halosilane compounds are defined as silanes that have at least one halogen (such as, for example, chlorine or fluorine) directly bonded to silicon wherein, within the scope of this disclosure, silanes are defined as silicon-based monomers or oligomers that contain functionality that can react with water, the —OH groups on the cellulosic substrates and/or sizing agents or additional additives applied to the cellulosic substrates as appreciated herein. Halosilane compounds with a single halogen directly bonded to silicon are defined as monohalosilanes, halosilane compounds with two halogens directly bonded to silicon are defined as dihalosilanes, halosilane compounds with three halogens directly bonded to silicon are defined as trihalosilanes and halosilane compounds with four halogens directly bonded to silicon are defined as tetrahalosilanes.

Monomeric halosilane compounds can comprise the formula RₙSiXₘH(₄₋ₙ₋ₘ) where n=0-3, or alternatively, n=0-2, m=1-4, or alternatively, m=2-4, each X is independently chloro, fluoro, bromo or iodo, or alternatively, each X is chloro and each R is independently an alkyl, aryl, aralkyl, or alkaryl group containing 1 to 20 carbon atoms. Alternatively, each R is independently an alkyl group containing 1 to 11 carbon atoms, an aryl group containing 6 to 14 carbon atoms and an alkenyl group containing 2 to 12 carbon atoms. Alternatively, each R is methyl or octyl. One such exemplary halosilane compound is methyltrichlorosilane or MeSiCl₃ where Me represents a methyl group (CH₃). Another exemplary halosilane compound is dimethyldichlorosilane or Me₂SiCl₂. Yet other examples of halosilane compounds include (chloromethyl)trichlorosilane, [3-(heptafluoroisoproxy)propyl]trichlorosilane, 1,6-bis(trichlorosilyl)hexane, 3-bromopropyltrichlorosilane, allylbromodimethylsilane, allyltrichlorosilane, (bromomethyl)chlorodimethylsilane, bromodimethylsilane, chloro(chloromethyl)dimethylsilane, chlorodiisopropyloctysilane, chlorodiisopropylsilane, chlorodimethylethylsilane, chlorodimethylphenylsilane, chlorodimethylsilane, chlorodiphenylmethylsilane, chlorotriethylsilane, chlorotrimethylsilane, dichloromethylsilane, dichloromethylvinylsilane, diethyldichlorosilane, diphenyldichlorosilane, di-t-butylchlorosilane, ethyltrichlorosilane, iodotrimethylsilane, octyltrichlorosilane, pentyltrichlorosilane, propyltrichlorosilane, phenyltrichlorosilane, tetrachlorosilane, trichloro(3,3,3-trifluoropropyl)silane, trichloro(dichloromethyl)silane, trichlorovinylsilane, hexachlorodisilane, 2,2-dimethylhexachlorotrisilane, dimethyldifluorosilane, or bromochlorodimethylsilane. These and other halosilane compounds can be individually produced through methods known in the art or purchased from suppliers such as Dow Corning Corporation, Momentive Performance Materials, or Gelest. Furthermore, while specific examples of halosilanes compounds are explicitly listed herein, the above-disclosed examples are not intended to be limiting in nature. Rather, the above-disclosed list is merely exemplary and other halosilane compounds, such as oligomeric halosilanes and polyfunctional halosilanes, may also be used.

The plurality of halosilanes may be provided such that each halosilane compound comprises a mole percent of a total halosilane concentration. For example, where the plurality of halosilane compounds comprises only two halosilane compounds, the first halosilane compound will comprise X mole percent of the total halosilane concentration while the second halosilane compound will comprise 100-X mole percent of the total halosilane concentration. To promote the formation of a silicone resin when treating the cellulosic substrate with the plurality of halosilane compounds as will become appreciated herein, the total halosilane concentration of the plurality of halosilane compounds can comprise 20 mole percent or less of monohalosilanes, 70 mole percent or less of monohalosilanes and dihalosilanes (i.e., the total amount of monohalosilanes and dihalosilanes when combined does not exceed 70 mole percent), and at least 30 mole percent of trihalosilanes and tetrahalosilanes (i.e., the total amount of trihalosilanes and tetrahalosilanes when combined comprises at least 30 mole percent). In another embodiment, total halosilane concentration of the plurality of halosilane compounds can comprise 30 mole percent to 80 mole percent of trihalosilanes and/or tetrahalosilanes, or alternatively, 50 mole percent to 80 mole percent of trihalosilanes and/or tetrahalosilanes.

For example, in one exemplary embodiment, the first halosilane compound can comprise a trihalosilane (such as methyltrichlorosilane) and the second halosilane compound can comprise a dihalosilane (such as dimethyldichlorosilane). The first and second halosilane compounds (e.g., the trihalosilane and dihalosilane) can be combined such that the trihalosilane can comprise X percent of the total halosilane concentration where X is 90 mole percent to 50 mole percent, 80 mole percent to 55 mole percent, or 65 mole percent to 55 mole percent. It is noted that the ranges are intended to be exemplary only and not limiting in nature and that other variations or subsets may alternatively be utilized.

The plurality of halosilane compounds can be applied in a vapor or liquid form. Alternatively, the plurality of halosilane compounds are applied to the cellulosic substrate as one or more liquids. Specifically, each of the plurality of halosilane compounds (i.e., the first halosilane compound, the second halosilane compound and any additional halosilane compounds) can be applied to the cellulosic substrate as a liquid, either alone or in combination, with other halosilane compounds. As used herein, liquid refers to a fluid material having no fixed shape. In one embodiment, the halosilane compounds, alone or in combination, can comprise liquids themselves. In another embodiment, each halosilane compound can be provided in a solution (wherein the first halosilane compound is combined with a solvent prior to treatment of the cellulosic substrate) to create or maintain a liquid state. As used herein, “solution” comprises any mixture and/or combination of one or more halosilane compounds and/or solvents in a liquid state. In such an embodiment, the halosilane compound may originally comprise any form such that it combines with the solvent to form a liquid solution. In yet another embodiment, a plurality of halosilane compounds can be provided in a single solution (wherein the first halosilane compound and the second halosilane compound are combined with a solvent prior to treatment of the cellulosic substrate). The plurality of halosilane compounds, either alone or in any combination, may thereby comprise a liquid or comprise any other state that combines with a solvent to comprise a liquid so that the halosilane compounds are applied to the cellulosic substrate as one or more liquids. The various halosilane compounds may therefore be applied as one or more liquids simultaneously, sequentially or in any combination thereof onto the cellulosic substrate.

Thus, in one embodiment, a halosilane solution can be produced by combining at least the first halosilane compound (and any additional halosilane compounds) with a solvent. A solvent is defined as a substance that exhibits negligible reactivity with halosilanes or halosilane byproducts and will either dissolve the halosilane compounds (such as a chlorosilane) to form a liquid solution or substance that provides a stable dispersion of halosilane compounds that maintains uniformity for sufficient time to allow treatment of the cellulosic substrate. Appropriate solvents can be non-polar such as non-functional silanes (i.e. silanes that do not contain a reactive functionality such as tetramethylsilane), silicones, alkyl hydrocarbons, aromatic hydrocarbons, or hydrocarbons possessing both alkyl and aromatic groups; polar solvents from a number of chemical classes such as ethers, ketones, esters, thioethers, halohydrocarbons; and blends thereof. Specific nonlimiting examples of appropriate solvents include isopentane, pentane, hexane, heptane, petroleum ether, ligroin, benzene, toluene, xylene, naphthalene, α- and/or β-methylnaphthalene, diethylether, tetrahydrofuran, dioxane, methyl-t-butylether, acetone, methylethylketone, methylisobutylketone, methylacetate, ethylacetate, butylacetate, dimethylthioether, diethylthioether, dipropylthioether, dibutylthioether, dichloromethane, chloroform, chlorobenzene, tetramethylsilane, tetraethylsilane, hexamethyldisiloxane, octamethyltrisiloxane, hexamethylcyclotrisiloxane, octamethylcyclotetrasiloxane, and decamethylcyclopentasiloxane. For example, in one specific embodiment, the solvent comprises a hydrocarbon such as pentane, hexane or heptane. In another embodiment, the solvent comprises a polar solvent such as acetone. Other exemplary solvents include toluene, naphthalene, isododecane, petroleum ether, tetrahydrofuran (THF) or silicones. The at least first and second halosilane compounds can be combined to produce the halosilane solution through any available mixing mechanism. The halosilane compounds can be either miscible or dispersible with the solvent to allow for a uniform solution/dispersion.

Where the plurality of halosilane compounds comprise a halosilane solution, the plurality of halosilane compounds will comprise a certain weight percent of the halosilane solution. The weight percent specifically refers to the weight of the plurality of halosilane compounds (e.g. the first halosilane compound, the second halosilane compound and any additional halosilane compounds) with respect to the overall weight of halosilane solution (including any solvents or other additives used therein). Exemplary ranges of the halosilane compounds in the halosilane solution include from greater than zero weight percent to 40 weight percent or alternatively from greater than zero weight percent to 5 weight percent, from 5 weight percent to 10 weight percent, from 10 weight percent to 15 weight percent, from 15 weight percent to 20 weight percent, from 20 weight percent to 25 weight percent, from 25 weight percent to 30 weight percent, from 30 weight percent to 35 weight percent, or from 35 weight percent to 40 weight percent. As noted earlier, these ranges are intended to be exemplary only and not limiting on the disclosure. Accordingly, other embodiments may incorporate an alternative weight percent of the halosilane compounds in the cellulosic substrate even though not explicitly stated herein.

Once the plurality of halosilane compounds are provided (either separately, as a solution or combinations thereof), the cellulosic substrate is treated with the plurality of halosilane compounds to render it hydrophobic. The term “treated” (and its variants such as “treating,” “treat” and “treatment”) means applying the plurality of halosilane compounds as one or more liquids to the cellulosic substrate in an appropriate environment for a sufficient amount of time to allow for the plurality of halosilane compounds to penetrate, react with and bond to the cellulosic substrate. Without intending to be bound by a particular theory or mechanism, the plurality of halosilane compounds can react with the —OH functionality of the cellulosic substrate, the water within the cellulosic substrate and/or other sizing agents or additional additives therein to form a silicone resin. The silicone resin refers to any product of the reaction between the halosilane compounds and the cellulosic substrate and/or the water within the cellulosic substrate which renders the cellulosic substrate hydrophobic. Specifically, the halosilane compounds capable of forming two or more bonds can react with the hydroxyl groups distributed along the cellulose chains of the cellulosic substrate and/or the water contained therein to form a silicone resin disposed throughout the interstitial spaces of the cellulosic substrate and anchored to the cellulose chains of the cellulosic substrate. Where the halosilane compounds react with the water in the cellulosic substrate, the reaction can produce a HX product (where X is the halogen from the halosilane compound) and a silanol. The silanol may then further react with a halosilane compound or another silanol to produce the silicone resin. The different reaction mechanisms can continue substantially throughout the matrix of the cellulosic substrate, thereby treating the entire volume of a cellulosic substrate of appropriate thickness.

Treating the cellulosic substrate with the plurality of halosilane compounds can be achieved in a variety of ways. For example, without intending to be limited to the exemplary embodiments expressly disclosed herein, the halosilane compounds can be applied to the cellulosic substrate by being dropped onto the cellulosic substrate from a nozzle, by being sprayed through one or more nozzles onto one or both surfaces of the cellulosic substrate, by being poured onto the cellulosic substrate, by passing the cellulosic substrate through a contained amount of the plurality of halosilane compounds, or by any other method that can coat, soak, or otherwise allow the plurality of halosilane compounds to come into physical contact with the cellulosic substrate. In one embodiment, where halosilane compounds are applied separately (e.g. not as a single solution), the first halosilane compound, the second halosilane compound and any additional halosilane compounds can be applied simultaneously or sequentially to the cellulosic substrate or in any other repeating or alternating order. Likewise, in another embodiment, where a combination of separate halosilane compounds and halosilane solutions are used, the halosilane compounds and halosilane solutions may be also be applied simultaneously or sequentially or in any other repeating or alternating order.

For example, in one embodiment, where the cellulosic substrate comprises a roll of paper, the paper can be unrolled at a controlled velocity and passed through a treatment area where the plurality of halosilane compounds are dropped onto the top surface of the paper. The velocity of the paper can depend in part on the thickness of the paper and/or the amount of halosilane compounds to be applied and can range from 1 feet/minute (ft./min.) to 3000 ft./min., from 10 ft./min. to 1000 ft./min. or 20 ft./min to 500 ft./min. In one embodiment, within the treatment area one or more nozzles drop a halosilane solution onto one or both surfaces of the cellulosic substrate so that one or both surfaces of the cellulosic substrate is covered with the halosilane solution.

The cellulosic substrate treated with the halosilane compounds can then rest, travel or experience additional treatments to allow for the plurality of halosilane compounds to react with the cellulosic substrate and the water therein. For example, to allow for an adequate amount of time for reaction, the cellulosic substrate may be stored in a heated, cooled and/or humidity-controlled chamber and allowed to remain for an adequate residence time, or may alternatively travel about a specified path wherein the length of the path is adjusted such that the cellulosic substrate traverses the specified path in an amount of time adequate for the reaction to occur.

In one embodiment, the method further comprises exposing the treated cellulosic substrate to a basic compound (such as ammonia gas) after the plurality of halosilane compounds are applied to the cellulosic substrate. Basic compound refers to any chemical compound that has the ability to react with and neutralize the acid produced upon hydrolysis of the halosilane. For example, in one embodiment, the halosilane compounds are applied to the cellulosic substrate and passed through a chamber containing ammonia gas such that the cellulosic substrate is exposed to the ammonia gas. Without intending to be bound by a particular theory, the basic compound may both neutralize acids generated from applying the halosilane compounds to cellulosic substrate and further drive the reaction between the halosilane compounds, water and the cellulosic substrate to completion. Other non-limiting examples of useful basic compounds include both organic and inorganic bases such as hydroxides of alkali earth metals or amines. In another embodiment, any other base and/or condensation catalyst may alternatively be used in whole or in part in place of the ammonia and delivered as a gas, a liquid, or in solution. In this context, the term “condensation catalyst” refers to any catalyst that can affect reaction between two silanol groups or a silanol group and an alkoxy silane to produce a siloxane linkage. In yet another embodiment, the cellulosic substrate may be exposed to the basic compound prior to, simultaneous with or after the plurality of halo silane compounds are applied, or in combinations thereof.

To increase the rate of reaction, the cellulosic substrate can also optionally be heated and/or dried after the halosilane compounds are applied to produce the silicone resin in the cellulosic substrate. For example, the cellulosic substrate can pass through a drying chamber in which heat is applied to the cellulosic substrate. In one embodiment, the drying chamber may comprise a temperature in excess of 200° C. In another embodiment, the temperature can vary depending on the speed in which the cellulosic substrate passes through the drying chamber, the thickness of the cellulosic substrate and/or the amount of halosilane compounds applied to the cellulosic substrate. In yet another embodiment, the temperature provided to the cellulosic substrate may be sufficient to heat the cellulosic substrate to 200° C. upon its exit from the drying chamber.

Once the cellulosic substrate is treated to render it hydrophobic, the hydrophobic cellulosic substrate will comprise the silicone resin from the reaction between the halosilane compounds and the cellulosic substrate and/or the water within the cellulosic substrate as discussed above. The silicone resin can comprise anywhere from greater than zero weight percent of the cellulosic substrate to 10 weight percent of the cellulosic substrate. The weight percent refers to the weight of the silicone resin (from the reaction of the halosilane solution) with respect to the overall weight of both the cellulosic substrate and the silicone resin. Other ranges of the silicone resin in the cellulosic substrate include from 0.01 weight percent to 5 weight percent or from 0.1 weight percent to 0.9 weight percent.

Without intending to be bound by a particular theory, it is believed that by mixing different halosilane compounds in varying ratios and amounts to form halosilane solutions, the cellulosic products treated with the plurality of halosilane compounds can attain different physical properties based in part on the types and amounts of the specific halosilane compounds employed. For example, an additional benefit of treating a cellulosic substrate with a plurality of halosilane compounds as disclosed herein is that the treatment can result in a net strengthening of the cellulosic substrate as well as imparting hydrophobicity. The silicone resin formed within the cellulose fibers of the cellulosic substrate reinforce the cellulosic substrate both by literally bridging the cellulose fibers with chemical bonds to the silicon atom (via reaction with a portion of the R—OH residues along the cellulose chain) and by forming a silicone resin network within the interstitial spaces between the fibers as discussed above. In particular, such a silicone resin may strengthen cellulosic substrates comprising recycled fibers wherein the strength of the recycled fibers has been reduced with each recycling due to the reduction in length of cellulose fibers that occurs as a result of breaking down of the pulp. Thus, not only will the halosilane compounds provide hydrophobic properties to the cellulosic structure, but other physical properties (such as, for example, wet tear strength and tensile strength) can also be maintained or improved relative to the untreated substrate as a result of treatment with the halosilane compounds. In addition, it is further believed that by mixing different halosilane compounds in varying ratios and amounts to form halosilane solutions, the deposition efficiencies of the halosilane solutions may increase allowing for the methods of rendering cellulosic substrates hydrophobic to become more efficient by achieving greater halosilane deposition during treatment.

### EXAMPLE 1

Cellulosic substrates (24 point unsized kraft paper) were individually treated with various halosilane solutions. Halosilane solutions were tested wherein the first halosilane compound comprised methyltrichlorosilane and the second halosilane compound comprised dimethyldichlorosilane. The halosilane solutions were 2.5 (low treatment level) and 10 (high treatment level) weight percent (wt %) of halosilane compounds with respect to the total weight of the overall halosilane solution (including the solvent pentane) and the mole percent ratios of methyltrichlorosilane to dimethyldichlorosilane were varied. Specifically, ranges of the first and second halosilane compounds in the chlorosilane solution were varied such that the first halosilane compound (methyltrichlorosilane) comprised 100 mole percent, 80 mole percent, or 60 mole percent. Accordingly, the halosilane solutions further comprised 0 mole percent, 20 moles percent, or 40 mole percent of the second halosilane compound (dimethyldichlorosilane) respectively. The halosilane solutions were prepared by mixing appropriate amounts of methyltrichlorosilane and dimethyldichlorosilane with pentane as a solvent. The paper was provided at about 22° C. and at 50 percent relative humidity. The paper was fed at a speed of 10 ft./min. to 30 ft./min. while being treated with the halosilane solution on one side.

The compositions of the mixtures of halosilanes are presented in Table 1:

TABLE 1
Representative halosilane compositions used in the treatment of
cellulosic substrates.

| | | | Relative Concentration | |
|---|---|---|---|---|
| | Halosilane(s) | | (mol %) | |
| Solution | (wt. %) | Solvent | MeSiCl₃ | Me₂SiCl₂ |
| 1 | 2.5 | Pentane | 100 | 0 |
| (Comparative) | | | | |
| 2 | 10 | Pentane | 100 | 0 |
| (Comparative) | | | | |
| 3 | 2.5 | Pentane | 80 | 20 |
| 4 | 10 | Pentane | 80 | 20 |
| 5 | 2.5 | Pentane | 60 | 40 |
| 6 | 10 | Pentane | 60 | 40 |

The hydrophobic attributes of the treated cellulosic substrates were then evaluated via the Cobb sizing test and immersion in water for 24 hours. The Cobb sizing test was performed in accordance with the procedure set forth in TAPPI testing method T441 where a 100 cm² surface of the paper is exposed to 100 mL of 50° C. deionized water for 3 minutes. The reported value is the mass (g) of water absorbed per square meter (g/m²) by the treated cellulosic substrate. The immersion test was conducted by completely immersing 6″×6″ (15.24 cm×15.24 cm) pieces of a treated cellulosic substrate in a bath of deionized water for a uniform period of time (e.g. 24 hours) with the uptake of water expressed as a percent weight gain. The strength properties of the paper were further evaluated by measuring the tensile strength of 1″ (2.54 cm) wide strips cut from both the machine and cross directions of the paper. The dry and wet tear values were evaluated in accordance with the procedure set forth in TAPPI test method T414. Treated cellulosic substrates were soaked in water at 22° C. for one hour prior to performing the measurements to obtain the wet tear values. Strength properties were tested in both the machine direction and the cross direction. The machine direction refers to the direction in which the fibers in the paper generally align as influenced by the direction of feeding through the machine when the cellulosic substrate is made. The cross direction refers to the direction perpendicular to the direction in which the fibers in the paper generally align.

The results from the evaluation of the hydrophobic and strength properties of the cellulosic substrates treated with a single chlorosilane (methyltrichlorosilane) in addition to those treated with a mixture of chlorosilanes (methyltrichlorosilane and dimethyldichlorosilane) are presented in Table 2:

TABLE 2
Water resistance and strength properties of cellulosic substrates (untreated
and treated) with halosilane solutions (where MD denotes machine direction and CD
denotes cross direction). Solutions were delivered from pentane.

| | | 1 | | | 2 | | |
|---|---|---|---|---|---|---|---|
| Solution | None | (Comparative) | 3 | 5 | (Comparative) | 4 | 6 |
| Treatment Level | Untreated | 2.5 | 2.5 | 2.5 | 10 | 10 | 10 |
| (wt %) | Paper | | | | | | |
| Paper Caliper | 24 pt. | 24 pt. | 24 pt. | 24 pt | 24 pt. | 24 pt. | 24 pt |
| Cobb Value (g/m²) | | | | | | | |
| Topside | 666 | 57 | 56 | 56 | 48 | 48 | 51 |
| Backside | 661 | 49 | 58 | 53 | 49 | 46 | 51 |
| Immersion | 154 | 54.4 | 55.4 | 55.2 | 54.7 | 53.3 | 56.0 |
| (24 h, wt %) | | | | | | | |
| Tensile (lbs.) | | | | | | | |
| MD | 146 | 145 | 156 | 155 | 154 | 148 | 148 |
| CD | 48.7 | 47.3 | 47.7 | 49.8 | 46.2 | 49.9 | 49.9 |
| Dry Tear (g) | | | | | | | |
| MD | 435 | 419 | 442 | 427 | 408 | 430 | 428 |
| CD | 564 | 497 | 518 | 537 | 520 | 548 | 517 |
| Wet Tear | | | | | | | |
| MD | 167 | 261 | 273 | 264 | 286 | 298 | 325 |
| CD | 165 | 320 | 292 | 299 | 320 | 321 | 354 |

Overall, the treated cellulosic substrates (Table 2) exhibited better water resistance properties in comparison to the untreated cellulosic substrates. Specifically, the Cobb value for the untreated cellulosic substrate was over 660 g/m². All of the treated cellulosic substrates (treated with solutions 1, 2, 3, 4, 5, and 6) exhibited substantial water resistance with Cobb values of approximately 50 g/m². The same conclusion can be drawn from the immersion results wherein the treated substrates absorb substantially less water than the untreated cellulosic substrates. It should also be noted that the Cobb values are nearly the same for both the front side (where the treatment solution was applied) and the back side (side opposite of where the treatment solution was applied. This result illustrates the ability of the treating solution to penetrate and render the cellulosic substrate water resistant throughout the entire volume. The results from the evaluation of tensile strengths demonstrate that the treatments generally increase the tensile strength over that of untreated paper. It can be seen that for paper treated with the 2.5 wt % solution of methyltrichlorosilane (Comparative, 1), no improvement in tensile strength of the paper is observed. However, when treated with mixtures of methyltrichlorosilane and dimethyldichlorosilane applied at 2.5 wt % (low treatment level, solutions 3 and 5), increases in the tensile values by 6%-8% in the machine direction (MD) relative to both untreated paper and paper treated with a 2.5 wt % solution of methyltrichlorosilane in pentane (comparative solution 1) are observed. An increase in the tensile strength in the cross direction (CD) is also observed for paper treated with solution 5 of about 2% relative to untreated paper and 5% relative to paper treated with comparative solution 1. When treated higher concentrations of methyltrichlorosilane and dimethyldichlorosilane mixtures, strength in the cross direction (MD) is increased by about 2% relative to the untreated substrate and by 8% relative to paper treated with comparative solution 2.

In general, the treatment of the paper substrate with the mixtures of methyltrichlorosilane and dimethyldichlorosilane (solutions 3, 4, 5, and 6) has a more beneficial effect on the tear properties of the paper than treatments with methyltrichlorosilane only (Comparative solutions 1 and 2). Paper treated with solutions 3 and 5 (low treatment level) exhibits improvements in dry tear strength of 2% to 5% in the machine direction and 4% to 7% in the cross direction relative to paper treated with Comparative solution 1. For high treatment levels, solution 4 improves the dry tear by 5% in both the machine and cross directions while solution 6 improves the machine direction value by 5% relative to Comparative solution 2. Solution 3, a low level treatment, imparts an approximate 2% increase in dry tear strength in the machine direction of the untreated substrate whereas Comparative solution 1 reduces that value by 4%.

In general, all samples of the cellulosic substrate showed increased wet tear strength relative to the untreated substrate. However, treatment with solution 6 (high treatment level) resulted in a 95% improvement for the wet tear strength in the machine direction (MD) and a 115% improvement for the cross direction (CD). In comparison, treatment with solution 1 (comprising only a single halosilane compound) resulted in only 71% and 94% improvements, respectively. Based on these results, and without intending to be bound by any one particular theory, it is believed that the addition of the dimethyldichlorosilane resulted in a modification of the structure of the silicone resin formed within and throughout the cellulosic substrate to aid in increasing the wet tear resistance of the cellulosic substrate. Specifically, it is believed that increasing the dimethylsiloxy component increased the strength of the silicone resin compared to the relatively brittle resin produced from the single halosilane compound. Thus, where water breaks down the cellulose fiber network of the cellulosic substrate, the increased strength of the silicone resin increases the wet tear strength of the cellulosic substrate. On the other hand, treatment with solution 3 (low treatment level) demonstrated improved dry tear strength and tensile strength compared with solution 1 comprising a single halosilane compound. Thus, properties such as hydrophobicity and strength may variably improve based on multiple factors such as the substrate thickness, the solution composition the number of different halosilane compounds and/or the overall concentration of halosilane compounds in the halosilane solution. Taking these variables into consideration may thereby allow for a substrate's properties to be tailored based on specific requirements.

### EXAMPLE 2

Increasingly complex halosilane mixtures were also used to treat 24 pt kraft paper. These halosilane solutions, comprising 2.5 weight percent (wt %) with respect to the total weight of the overall halosilane solution (including the solvent pentane), were chosen to span a range of average functionality for the halosilanes that go on to react with water and carbinol groups within the substrate to form the crosslinked resin. If the average functionality is two or less, only linear polymers and oligomers are formed. Crosslinked structures can form when the average functionality is greater than two. As an example, and without intending to be bound by any one particular theory, the crosslinked material, or resin, would likely be a “soft” or pliable material when the average functionality of the components is near, but greater than, two. After the average functionality of the components surpasses a value of two and approaches 3 or 4, the crosslinked structure or resin may exhibit properties of toughness, brittleness, or both. In this example, the molar ratios of trimethylchlorosilane, dimethyldichlorosilane, methyltrichlorosilane and silicon tetrachloride were chosen such that the average functionality would range from 2.1 to 3.7 so that resins formed within and throughout the paper would range from soft in nature to tough and brittle. The resulting ranges of chlorosilanes were 10 to 20 mole percent trimethylchlorosilane, 10 to 70 mole percent dimethyldichlorosilane, 30 to 60 mole percent methyltrichlorosilane, and 5 to 70 mole percent silicon tetrachloride. The various compositions of treating solution are presented in Table 3 below:

TABLE 3
Representative halosilanes compositions used in the treatment of cellulosic substrates.

| | Halosilane(s) | | Relative Concentration (mol %) | | | | Average |
|---|---|---|---|---|---|---|---|
| Solution | (wt. %) | Solvent | SiCl₄ | MeSiCl₃ | Me₂SiCl₂ | Me₃SiCl | Functionality |
| 7 | 2.5 | Pentane | — | 100 | — | — | 3 |
| (Comparative) | | | | | | | |
| 8 | 2.5 | Pentane | — | 30 | 50 | 20 | 2.1 |
| 9 | 2.5 | Pentane | — | 30 | 60 | 10 | 2.2 |
| 10 | 2.5 | Pentane | — | 30 | 70 | — | 2.3 |
| 11 | 2.5 | Pentane | 5 | 30 | 65 | — | 2.4 |
| 12 | 2.5 | Pentane | 10 | 30 | 60 | — | 2.5 |
| 13 | 2.5 | Pentane | 10 | 40 | 40 | 10 | 2.5 |
| 14 | 2.5 | Pentane | 10 | 50 | 30 | 10 | 2.6 |
| 15 | 2.5 | Pentane | 10 | 60 | 20 | 10 | 2.7 |
| 16 | 2.5 | Pentane | 20 | 30 | 50 | — | 2.7 |
| 17 | 2.5 | Pentane | 30 | 30 | 40 | — | 2.9 |
| 18 | 2.5 | Pentane | 40 | 40 | 20 | — | 3.2 |
| 19 | 2.5 | Pentane | 40 | 50 | 10 | — | 3.3 |
| 20 | 2.5 | Pentane | 40 | 60 | — | — | 3.4 |
| 21 | 2.5 | Pentane | 50 | 50 | — | — | 3.5 |
| 22 | 2.5 | Pentane | 60 | 40 | — | — | 3.6 |
| 23 | 2.5 | Pentane | 70 | 30 | — | — | 3.7 |

From the results shown in Tables 4 and 5 below, it can be seen that paper treated with three or more chlorosilanes results in similar performance in comparison to paper treated with methyltrichlorosilane (a single chlorosilane, compartive solution 7). The Cobb values are generally equal to or better for the paper treated using solutions 8 through 23. In general, treatment with chlorosilanes lead to an increase in the tensile strength of the paper in the machine direction over that of untreated paper. Treatment of the paper with a 2.5 wt % solution of methyltrichlorosilane (Comparative solution 7) resulted in a 0.7% increase in tensile strength in the machine direction. With exception to solution 11, all of the papers treated with solutions 8 through 23 exhibited increases in strength ranging from 1.3% to 7.9%. Improvements also observed for the tensile values in the cross direction. While no improvement is observed for paper treated with Comparative solution 7, solution 8 and solutions 11 through 23, impart increases in strength ranging from 0.3% to 5.2%.

This example further illustrates the potential benefits of treating a cellulosic substrate with a mixture of chlorosilanes rather than a single chlorosilane such as methyltrichlorosilane. The process for manufacturing chlorosilanes, although targeted to make dimethyldichlorosilane, can result in a broad distribution of a mixture of products. The additional processing required, which typically involves distillations, can thereby add to the cost of the raw materials. Since the mixtures may be obtained at a lower cost, it can offer a more economical alternative to treating cellulosic substrates than the use of a single purified chlorosilane. The range of compositions used in this example encompass a range of average functionality of the components to demonstrate the effect on the properties of the treated paper by the cross-linked resin, whether “soft” or “hard,” impregnated in the paper. One may thereby have the option of obtaining the pure components and combining them in the appropriate ratios to target specific improvements in particular properties. One would also have the flexibility, and optionally lower cost, to obtain a crude mixture of chlorosilanes and augment the composition with the appropriate chlorosilane(s) to obtain a target or ideal composition aimed at imparting specific properties to the treated substrate.

TABLE 4
Water resistance and strength properties of cellulosic substrates (untreated and treated)
with halosilane solutions (where MD denotes machine direction and CD denotes cross direction).

| | Untreated | 7 | | | | | | | | |
|---|---|---|---|---|---|---|---|---|---|---|
| Solution | Paper | (Comparative) | 8 | 9 | 10 | 11 | 12 | 13 | 14 | 15 |
| Paper Caliper (pt.) | 24 | 24 | 24 | 24 | 24 | 24 | 24 | 24 | 24 | 24 |
| Cobb Value (g/m²) | | | | | | | | | | |
| Topside | 700 | 50 | 47 | 51 | 44 | 50 | 46 | 52 | 46 | 46 |
| Backside | 716 | 46 | 49 | 52 | 47 | 50 | 47 | 50 | 46 | 50 |
| Immersion (24 h, wt %) | — | 61.9 | 79.3 | 69.6 | 65.9 | 63.4 | 65.0 | 61.7 | 61.9 | 63.6 |
| Tensile (lbs.) | | | | | | | | | | |
| MD | 151 | 152 | 157 | 156 | 159 | 149 | 162 | 164 | 155 | 157 |
| CD | 67.0 | 67.0 | 68.1 | 66.2 | 66.1 | 67.8 | 67.7 | 68.4 | 69.9 | 68.7 |
| Dry Tear (g) | | | | | | | | | | |
| MD | 510 | 502 | 487 | 455 | 482 | 503 | 462 | 472 | 507 | 453 |
| CD | 724 | 1002 | 608 | 630 | 662 | 641 | 735 | 668 | 724 | 652 |
| Wet Tear | | | | | | | | | | |
| MD | 235 | 471 | 372 | 367 | 385 | 386 | 364 | 311 | 430 | 323 |
| CD | 254 | 561 | 414 | 432 | 391 | 399 | 431 | 419 | 413 | 451 |

TABLE 5
Water resistance and strength properties of cellulosic substrates (untreated and treated) with halosilane
solutions (where MD denotes machine direction and CD denotes cross direction).

| | Untreated | 7 | | | | | | | | |
|---|---|---|---|---|---|---|---|---|---|---|
| Solution | Paper | (Comparative) | 16 | 17 | 18 | 19 | 20 | 21 | 22 | 23 |
| Paper Caliper (pt.) | 24 | 24 | 24 | 24 | 24 | 24 | 24 | 24 | 24 | 24 |
| Cobb Value (g/m²) | | | | | | | | | | |
| Topside | 700 | 50 | 50 | 47 | 52 | 46 | 52 | 48 | 48 | 54 |
| Backside | 716 | 46 | 47 | 44 | 49 | 46 | 49 | 42 | 48 | 50 |
| Immersion (24 h, wt %) | — | 61.9 | 66.8 | 64.9 | 73.1 | 74.3 | 74.2 | 68.1 | 68.0 | 89.2 |
| Tensile (lbs.) | | | | | | | | | | |
| MD | 151 | 152 | 153 | 157 | 158 | 162 | 164 | 155 | 159 | 158 |
| CD | 67 | 67 | 67.1 | 67.2 | 68.2 | 68.8 | 70.7 | 68.8 | 68.6 | 69.8 |
| Dry Tear (g) | | | | | | | | | | |
| MD | 510 | 502 | 464 | 515 | 495 | 541 | 507 | 500 | 457 | 471 |
| CD | 724 | 1002 | 670 | 593 | 631 | 776 | 611 | 641 | 764 | 735 |
| Wet Tear | | | | | | | | | | |
| MD | 235 | 477 | 351 | 382 | 398 | 375 | 351 | 454 | 319 | 351 |
| CD | 254 | 561 | 418 | 389 | 327 | 481 | 366 | 412 | 468 | 391 |

### EXAMPLE 3

Silanes with ethyl, propyl or octyl substituents, such as those also used in other applications (e.g., masonry protection) where it may be desired to impart water resistance to a substrate, were also explored. Such silanes may be obtained through platinum catalyzed hydrosilylation of trichlorosilane with ethylene, 1-propene, or 1-octene, respectively. Additional expense may be incurred during the manufacture of these compounds due to being an additional step and also due to the high cost of the platinum catalyst. A route toward reducing the overall cost of using these materials in an application, such as treatments for cellulosic substrates would be incorporate them as components in mixture of less expensive chemicals. An additional benefit to this approach is that performance enhancements can be obtained relative to cellulosic substrates treated with the single chlorosilane.

Similar to Example 1 above, binary mixtures of various trichlorosilanes and dichlorosilanes were made. In Table 6, the ratios of octyltrichlorosilane (OctSiCl₃) and dimethyldichlorosilane used in making exemplary treating solutions are shown. The results of treating a cellulosic substrate with the mixtures in Table 6 are displayed in Table 7. It can be seen that treatment of the paper with a 10 wt % solution of octyltrichlorosilane leads to significantly improved Cobb and Wet Tear values over the untreated substrate. However, the tensile and dry tear values are reduced. Overall, the same trend is observed for the mixtures of octyltrichlorosilane and dimethyldichlorosilane (solutions 25, 26, and 27) are used to treat the cellulosic substrate. Paper treated with solutions 26 and 27 do exhibit increased tensile values in both the machine and cross direction relative to Comparative solution 24 ranging from 2.5% to 7.4%. Solution 25 provides a benefit for the dry tear strength relative to the Comparative solution that amounts to a 4.4% increase. The values for wet tear benefit significantly from treatments that incorporate a mixture of the octyltrichlorosilane and dimethyldichlorosilane. Paper treated with solution 27 has 7.8% more wet tear strength than the Comparative solution in the cross direction. Treatment with solutions 25, 26, and 27 results in an increase of 2.5% to 36% increase in strength for the wet tear in the machine direction over that of the Comparative solution (24).

TABLE 6
Representative halosilane compositions used in the treatment
of cellulosic substrates.

| | | | Relative Concentration | |
|---|---|---|---|---|
| | Halosilane(s) | | (mol %) | |
| Solution | (wt. %) | Solvent | OctSiCl₃ | Me₂SiCl₂ |
| 24 | 10 | Pentane | 100 | 0 |
| (Comparative) | | | | |
| 25 | 10 | Pentane | 80 | 20 |
| 26 | 10 | Pentane | 60 | 40 |
| 27 | 10 | Pentane | 40 | 60 |

TABLE 7
Water resistance and strength properties of cellulosic substrates
(untreated and treated) with halosilane solutions (where MD denotes
machine direction and CD denotes cross direction).

| | Solution | | | | |
|---|---|---|---|---|---|
| | | 24 | | | |
| | None | (Comparative) | 25 | 26 | 27 |
| Paper Caliper | 24 pt. | 24 pt. | 24 pt. | 24 pt. | 24 pt |
| Cobb Value (g/m²) | | | | | |
| Topside | 693 | 28 | 28 | 29 | 29 |
| Backside | 696 | 31 | 29 | 29 | 29 |
| Tensile (lbs.) | | | | | |
| MD | 157 | 121 | 111 | 130 | 125 |
| CD | 69 | 55.3 | 51.4 | 58.0 | 56.7 |
| Dry Tear (g) | | | | | |
| MD | 510 | 387 | 404 | 376 | 368 |
| CD | 724 | 559 | 416 | 481 | 468 |
| Wet Tear | | | | | |
| MD | 235 | 322 | 330 | 370 | 438 |
| CD | 235 | 408 | 384 | 403 | 440 |

Mixtures made with another pair of chlorosilanes, propyltrichlorosilane (PrSiCl₃) and dimethyldichlorosilane (Table 8), improved the properties (Table 9) of treated paper versus that treated with only propyltrichlorosilane. The Cobb values of paper treated with the mixtures, solutions 29, 30, and 31 similar to those obtained from treatment of the paper with the Comparative solution, 28. Improvements in the wet tear values of approximately 17% and 4.5% result when paper was treated with solutions 29 and 31, respectively, relative to paper treated with 28.

TABLE 8
Representative halosilane compositions used in the treatment of
cellulosic substrates.

| | | | Relative Concentration | |
|---|---|---|---|---|
| | Halosilane(s) | | (mol %) | |
| Solution | (wt. %) | Solvent | PrSiCl₃ | Me₂SiCl₂ |
| 28 | 10 | Pentane | 100 | 0 |
| (Comparative) | | | | |
| 29 | 10 | Pentane | 80 | 20 |
| 30 | 10 | Pentane | 60 | 40 |
| 31 | 10 | Pentane | 40 | 60 |

TABLE 9
Water resistance and strength properties of cellulosic substrates
(untreated and treated) with halosilane solutions (where MD denotes
machine direction and CD denotes cross direction).

| | Solution | | | | |
|---|---|---|---|---|---|
| | | 28 | | | |
| | None | (Comparative) | 29 | 30 | 31 |
| Paper Caliper | 24 pt. | 24 pt. | 24 pt. | 24 pt. | 24 pt |
| Cobb Value (g/m²) | | | | | |
| Topside | 693 | 34 | 34 | 38 | 36 |
| Backside | 696 | 32 | 33 | 34 | 39 |
| Tensile (lbs.) | | | | | |
| MD | 157 | 153 | 129 | 145 | 135 |
| CD | 69 | 63.9 | 60.1 | 58.9 | 59.9 |
| Dry Tear (g) | | | | | |
| MD | 510 | 520 | 418 | 445 | 436 |
| CD | 724 | 660 | 543 | 604 | 540 |
| Wet Tear | | | | | |
| MD | 235 | 446 | 523 | 425 | 466 |
| CD | 235 | 583 | 506 | 433 | 497 |

Mixtures made with another pair of chlorosilanes, ethyltrichlorosilane (EtSiCl₃) and diethyldichlorosilane (Et₂SilCl₂) (Table 10), improved the properties (Table 11) of treated paper versus that treated with only ethyltrichlorosilane. Treatments using solutions 33, 34, and 35 improve the tensile values in the cross direction by 4.4% to 9.1% over paper treated with Comparative solution 32 Improvements of 22% to 34% in the machine direction dry tear value are also observed when 33, 34, and 35 are used as the treatments. Solutions 33 and 35 increase the wet tear in the machine direction by 2.6 and 11%, respectively, relative to the Comparative solution (32).

TABLE 10
Representative halosilane compositions used in the treatment of
cellulosic susbstrates.

| | | | Relative Concentration | |
|---|---|---|---|---|
| | Halosilane(s) | | (mol %) | |
| Solution | (wt. %) | Solvent | EtSiCl₃ | Et₂SiCl₂ |
| 32 | 10 | Pentane | 100 | 0 |
| (Comparative) | | | | |
| 33 | 10 | Pentane | 80 | 20 |
| 34 | 10 | Pentane | 60 | 40 |
| 35 | 10 | Pentane | 40 | 60 |

TABLE 11
Water resistance and strength properties of cellulosic substrates
(untreated and treated) with halosilane solutions (where MD denotes
machine direction and CD denotes cross direction).

| | Solution | | | | |
|---|---|---|---|---|---|
| | | 32 | | | |
| | None | (Comparative) | 33 | 34 | 35 |
| Paper Caliper | 24 pt. | 24 pt. | 24 pt. | 24 pt. | 24 pt |
| Cobb Value (g/m²) | | | | | |
| Topside | 693 | 43 | 44 | 44 | 46 |
| Backside | 696 | 40 | 39 | 40 | 44 |
| Tensile (lbs.) | | | | | |
| MD | 157 | 149 | 135 | 130 | 120 |
| CD | 69 | 63.5 | 69.3 | 66.5 | 66.3 |
| Dry Tear (g) | | | | | |
| MD | 510 | 461 | 561 | 618 | 561 |
| CD | 724 | 757 | 717 | 698 | 677 |
| Wet Tear | | | | | |
| MD | 235 | 390 | 432 | 387 | 400 |
| CD | 235 | 492 | 477 | 438 | 396 |

Mixtures made with another pair of chlorosilanes, methyltrichlorosilane and diphenyldichlorosilane (Ph₂SiCl₂) (Table 12), improved the properties (Table 13) of treated paper versus that treated with only methyltrichlorosilane. In this case, all of the treatments that were a mixture, 37, 38, and 39, led to improved performance in regards to the Cobb values on the backside of the paper. Treatments using solutions 37, 38, and 39 improve the dry tear values of the paper in the cross direction by 9.7% to 14% over paper treated with Comparative solution 36. Improvements of 4.9% to 14% in the cross direction wet tear value are also observed when 37, 38, and 39 are used as the treatments.

TABLE 12
Representative halosilane compositions used in the treatment of
cellulosic substrates.

| | | | Relative Concentration | |
|---|---|---|---|---|
| | Halosilane(s) | | (mol %) | |
| Solution | (wt. %) | Solvent | MeSiCl₃ | Ph₂SiCl₂ |
| 36 | 10 | Pentane | 100 | 0 |
| (Comparative) | | | | |
| 37 | 10 | Pentane | 80 | 20 |
| 38 | 10 | Pentane | 60 | 40 |
| 39 | 10 | Pentane | 40 | 60 |

TABLE 13
Water resistance and strength properties of cellulosic substrates
(untreated and treated) with halosilane solutions (where MD denotes
machine direction and CD denotes cross direction).

| | Solution | | | | |
|---|---|---|---|---|---|
| | | 36 | | | |
| | None | (Comparative) | 37 | 38 | 39 |
| Paper Caliper | 24 pt. | 24 pt. | 24 pt. | 24 pt. | 24 pt |
| Cobb Value (g/m²) | | | | | |
| Topside | 693 | 44 | 47 | 44 | 50 |
| Backside | 696 | 40 | 34 | 31 | 36 |
| Tensile (lbs.) | | | | | |
| MD | 157 | 136 | 127 | 122 | 124 |
| CD | 69 | 69.6 | 67.1 | 65.0 | 66.4 |
| Dry Tear (g) | | | | | |
| MD | 510 | 504 | 442 | 449 | 495 |
| CD | 724 | 608 | 695 | 667 | 682 |
| Wet Tear | | | | | |
| MD | 235 | 486 | 407 | 427 | 456 |
| CD | 235 | 472 | 495 | 536 | 495 |

As demonstrated, specific mixtures may change different properties of the treated cellulosic substrates. This may allow one to tailor the final product for a particular application. For example, in some cases, it may be important to improve the tensile strength of the paper. Doing so may allow one to use lower caliper (i.e., thinner) paper and save weight used in packaging. In another example, some applications may have critical requirements for the dry tear or the wet tear and could require specific improvements for a particular direction of the paper (machine versus cross direction) for example. These performance properties may thereby be adjusted by using mixtures of octyltrichlorosilane and dimethyldichlorosilane in place of the octyltrichlorosilane. A propyltrichlorosilane/dimethyldichlorosilane combination may alter the wet tear values substantially for both directions of the paper compared to that of propyltrichlorosilane. The ethyltrichlorsilane/diethyldichlorosilane combination may alter the cross direction tensile values and also adjust the machine direction dry and wet tear values over paper treated only with ethyltrichlorosilane. Use of diphenyldichlorosilane in combination with methyltrichlorosilane may alter Cobb, cross direction dry tear, and cross direction wet tear values versus those of methyltrichlorosilane. The choice of these and other combinations of chlorosilanes to treat cellulosic substrates can thereby ultimately be determined by performance requirements, raw material costs, and availability.

### EXAMPLE 4

Deposition efficiency was calculated from the amount of chlorosilane(s) applied to the cellulosic substrate using the known variables of solution concentration, solution application rate, and paper feed rate. The amount of resin contained in the treated paper can be determined by converting the resin to monomeric alkoxysilane units and quantifying such using gas chromatography pursuant to the procedure described in “The Analytical Chemistry of Silicones,” Ed. A. Lee Smith. Chemical Analysis Vol. 112, Wiley-Interscience (ISBN 0-471-51624-4), pp 210-211. The deposition efficiency can then be determined by dividing the amount of resin in the paper by the amount of chlorosilanes applied.

Table 14 below lists the deposition efficiencies of the individual components in a mixture of methyltrichlorosilane and dimethyldichlorosilane. The deposition efficiency of methyltrichlorosilane alone is 22.6%. By adding dimethyldichlorosilane, the deposition efficiency of methyltrichlorosilane increases to values ranging from 29.7% to 56.1%. As shown in Table 15, a similar result is observed in the case of mixtures using propyltrichlorosilane and dimethyldichlorosilane. The deposition efficiency of propyltrichlorosilane alone is 55.7%, and with the addition of dimethyldichlorosilane, becomes 64.6% and up to 69.0%. Even with an initial deposition efficiency of 75.1% (Table 16), octyltrichlorosilane also experiences an improvement when dimethyldichlorosilane is incorporated in the mixture. Addition of the second chlorosilane bumps the efficiency up to 76.1 to 87.0%. Switching the difunctional component from dimethyldichlorosilane to diphenyldichlorosilane also aids the deposition efficiency (Table 17) of methyltrichlorosilane, 22.6%, by increasing it to values ranging from 24.3% to 38.2%.

TABLE 14
Deposition efficiencies of the individual chlorosilane components
from paper treated with a 10 wt % solution containing
methyltrichlorosilane and dimethyldichlorosilane in pentane.

| | | | Deposition | | |
|---|---|---|---|---|---|
| | Relative | | Efficiency | | |
| | Concentration | | (Individual | | Overall |
| | (mol %) | | Components) | | Deposition |
| Solution | MeSiCl₃ | Me₂SiCl₂ | MeSiCl₃ | Me₂SiCl₂ | Efficiency |
| 37 | 100 | — | 22.6% | — | 22.6% |
| (Com- | | | | | |
| parative) | | | | | |
| 41 | 80 | 20 | 29.7% | 37.4% | 31.3% |
| 42 | 60 | 40 | 43.7% | 43.1% | 43.5% |
| 43 | 40 | 60 | 56.1% | 45.3% | 49.5% |

TABLE 15
Deposition efficiencies of the individual chlorosilane components from
paper treated with a 10 wt % solution containing propyltrichlorosilane
and dimethyldichlorosilane in pentane.

| | Relative | | | | |
|---|---|---|---|---|---|
| | Concentration | | Deposition | | Overall |
| | (mol %) | | Efficiency | | Deposition |
| Solution | PrSiCl₃ | Me₂SiCl₂ | PrSiCl₃ | Me₂SiCl₂ | Efficiency |
| 28 | 100 | — | 55.7% | — | 55.7% |
| (Comparative) | | | | | |
| 29 | 80 | 20 | 64.7% | 41.6% | 62.1% |
| 30 | 60 | 40 | 69.0% | 45.6% | 63.2% |
| 31 | 40 | 60 | 64.6% | 44.1% | 56.0% |

TABLE 16
Deposition efficiencies of the individual chlorosilane components from
paper treated with a 10 wt % solution containing octyltrichlorosilane
and dimethyldichlorosilane in pentane.

| | Relative | | | | |
|---|---|---|---|---|---|
| | Concentration | | Deposition | | Overall |
| | (mol %) | | Efficiency | | Deposition |
| Solution | OctSiCl₃ | Me₂SiCl₂ | OctSiCl₃ | Me₂SiCl₂ | Efficiency |
| 24 | 100 | — | 75.1% | — | 75.1% |
| (Com- | | | | | |
| parative) | | | | | |
| 25 | 80 | 20 | 76.3% | 33.2% | 72.0% |
| 26 | 60 | 40 | 87.0% | 41.7% | 76.8% |
| 27 | 40 | 60 | 79.1% | 39.3% | 63.6% |

TABLE 17
Deposition efficiencies of the individual chlorosilane components from
paper treated with a 10 wt % solution containing methyltrichlorosilane
and diphenyldichlorosilane in pentane.

| | Relative | | | | |
|---|---|---|---|---|---|
| | Concentration | | Deposition | | Overall |
| | (mol %) | | Efficiency | | Deposition |
| Solution | MeSiCl₃ | Ph₂SiCl₂ | MeSiCl₃ | Ph₂SiCl₂ | Efficiency |
| 36 | 100 | — | 22.6% | — | 22.6% |
| (Com- | | | | | |
| parative) | | | | | |
| 37 | 80 | 20 | 24.3% | 91.1% | 52.2% |
| 38 | 60 | 40 | 28.7% | 98.8% | 74.2% |
| 39 | 40 | 60 | 38.2% | 97.8% | 85.9% |

1. A method for rendering a cellulosic substrate hydrophobic, the method comprising:
providing a plurality of halosilane compounds comprising at least a first halosilane compound and a second halosilane compound different from the first halosilane compound, wherein the plurality of halosilane compounds comprises a total halosilane concentration comprising 20 mole percent or less of monohalosilanes, 70 mole percent or less of monohalosilanes and dihalosilanes and at least 30 percent of trihalosilanes and tetrahalosilanes; and,
treating the cellulosic substrate with the plurality of halosilane compounds, wherein the plurality of halosilane compounds are applied as one or more liquids.

2. The method of claim 1 wherein each of the plurality of halosilane compounds comprises the formula RₙSiClₘH₍₄₋ₙ₋ₘ₎ where n=0-3, m=1-4, and R is an alkyl, aryl, aralkyl, or alkaryl group containing 1 to 20 carbon atoms.

3. The method of claim 1 wherein each of the halosilane compounds is selected from methyltrichlorosilane, dimethyldichlorosilane, ethyltrichlorosilane, diethyldichlorosilane, propyltrichlorosilane, diphenyldichlorosilane, octyltrichlorosilane, and tetrachlorosilane.

4. The method of claim 1 wherein the plurality of halosilane compounds is provided as a halosilane solution.

5. The method of claim 4 wherein the halosilane solution further comprises a non-polar solvent.

6. (canceled)

7. The method of claim 1 wherein the plurality of halosilane compounds comprises the total halosilane concentration comprising 20 mole percent to 95 mole percent of trihalosilanes.

8. (canceled)

9. The method of claim 1 wherein the plurality of halosilane compounds comprises the total halosilane concentration comprising 5 mole percent to 95 mole percent of tetrahalosilanes.

10. (canceled)

11. The method of claim 1 wherein the plurality of halosilane compounds further comprises a third halosilane compound, different from the first halosilane compound and the second halosilane compound.

12. The method of claim 1 further comprising exposing the cellulosic substrate to a basic compound after treatment with the plurality of halosilane compounds.

13. (canceled)

14. The method of claim 1 wherein the cellulosic substrate comprises paper, cardboard, boxboard, wood, wood products, wallboard, textiles, starches, cotton or wool.

15. The method of claim 1 wherein the cellulosic substrate comprises paper, cardboard or boxboard.

16. A hydrophobic cellulosic substrate comprising:
90 weight percent to 99.99 weight percent of a cellulosic substrate; and,
0.01 weight percent to 10 weight percent of a silicone resin, wherein the silicone resin is produced from treating the cellulosic substrate with a plurality of halosilane compounds comprising at least a first halosilane compound and a second halosilane compound different from the first halosilane compound, wherein the plurality of halosilane compounds are applied as one or more liquids and comprises a total halosilane concentration comprising 20 mole percent or less of monohalosilanes, 70 mole percent or less of monohalosilanes and dihalosilanes and at least 30 percent of trihalosilanes and tetrahalosilanes.

17. The hydrophobic cellulosic substrate of claim 16 comprising 99.1 weight percent to 99.9 weight percent of the cellulosic substrate and 0.1 weight percent to 0.9 weight percent of the silicone resin.

18. The hydrophobic cellulosic substrate of claim 16 wherein each of the plurality of halosilane compounds comprises the formula RₙSiClₘH₍₄₋ₙ₋ₘ₎ where n=0-3, m=1-4, and R is an alkyl, aryl, aralkyl, or alkaryl group containing 1 to 20 carbon atoms.

19. The hydrophobic cellulosic substrate of claim 17 wherein the first halosilane compound is selected from methyltrichlorosilane, dimethyldichlorosilane, ethyltrichlorosilane, diethyldichlorosilane, propyltrichlorosilane, diphenyldichlorosilane, octyltrichlorosilane, and tetrachlorosilane.

20. The hydrophobic cellulosic substrate of claim 16 wherein the plurality of halosilane compounds is provided as a halosilane solution.

21. The hydrophobic cellulosic substrate of claim 20 wherein the halosilane solution further comprises a non-polar solvent.

22. The hydrophobic cellulosic substrate of claim 16 wherein the cellulosic substrate is 1 mil to 150 mils thick.

23. The hydrophobic cellulosic substrate of claim 21 wherein the cellulosic substrate is 5 mils to 45 mils thick.

24. The hydrophobic cellulosic substrate of claim 16 wherein the cellulosic substrate comprises paper, cardboard, boxboard, wood, wood products, wallboard, textiles, starches, cotton, or wool.

25. (canceled)
